(19) United States
(12) Patent Application Publication
(10) Pub. No.: US 2010/0119420 A1
(43) Pub. Date: May 13, 2010

(54) ABATEMENT SYSTEM HAVING ENHANCED EFFLUENT SCRUB AND MOISTURE CONTROL

(75) Inventors: PHIL CHANDLER, San Francisco, CA (US); DANIEL O. CLARK, Pleasanton, CA (US); FRANK HOOSHDARAN, Pleasanton, CA (US); DAN S. BROWN, Los Gatos, CA (US); BARRY PAGE, San Jose, CA (US); ALLEN FOX, Sunnyvale, CA (US); GEORGE L. DANSEN, III, Georgetown, TX (US); JAY JUNG, Sunnyvale, CA (US)

Correspondence Address: MOSER IP LAW GROUP / APPLIED MATERIALS, INC., 1030 BROAD STREET, 2ND FLOOR, SHREWSBURY, NJ, 07702, US

(73) Assignee: APPLIED MATERIALS, INC., Santa Clara, CA (US)

(21) Appl. No.: 12/613,181

(22) Filed: Nov. 5, 2009

Related U.S. Application Data
(60) Provisional application No. 61/112,679, filed on Nov. 7, 2008.

(51) Int. Cl. B01D 53/82; B01J 19/00

(52) U.S. Cl. 422/171; 96/120

(57) ABSTRACT

Apparatus for improved treatment of effluents are provided herein. In some embodiments, an abatement system may include an exhaust conduit to flow an effluent stream therethrough; a plurality of packed beds disposed in the exhaust conduit to remove non-exhaustible effluents from the effluent stream; one or more spray jets to provide an effluent treating agent between adjacent packed beds, the effluent treating agent to remove non-exhaustible effluents from the effluent stream; and a dripper disposed in the exhaust conduit above an uppermost packed bed to provide the effluent treating agent in large droplets to wet and rinse particulate from an upper surface of the uppermost packed bed substantially without forming fine droplets.

### CROSS-REFERENCE TO RELATED APPLICATIONS

This application claims benefit of U.S. provisional patent application Ser. No. 61/112,679, filed Nov. 7, 2008, which is herein incorporated by reference in its entirety.

### FIELD

Embodiments of the present invention generally relate to processing equipment, and more specifically to abatement systems for treating effluents.

### BACKGROUND

Abatement systems are utilized at least in part for the removal of particles and/or hazardous effluent gases from an exhausting effluent stream prior to releasing the stream into the environment. For example, in the abatement system, the exhausting effluent stream may be combusted and then washed to remove particulates and/or water soluble effluents. In some abatement systems, the effluent stream is passed through a scrubber which can be utilized to remove particulates and/or hazardous effluents from the stream.

However, the inventors have discovered that in some applications, processing effluent with a scrubber may fail to adequately reduce hazardous gases, such as hydrogen fluoride (HF), silane (SiH₄), tetrafluorosilane (SiF₄) or the like, and/or particulate matter from the exhausting effluent stream.

Thus, the inventors have provided an improved abatement system that can advantageously further improve hazardous gas and particulate matter reduction from an effluent stream.

### SUMMARY

Apparatus for improved treatment of effluents are provided herein. In some embodiments, an abatement system may include an exhaust conduit to flow an effluent stream therethrough; a plurality of packed beds disposed in the exhaust conduit to remove non-exhaustible effluents from the effluent stream; one or more spray jets to provide an effluent treating agent between adjacent packed beds, the effluent treating agent to remove non-exhaustible effluents from the effluent stream; and a dripper disposed in the exhaust conduit above an uppermost packed bed to provide the effluent treating agent in large droplets to wet and rinse particulate from an upper surface of the uppermost packed bed substantially without forming fine droplets.

In some embodiments, an abatement system may include an exhaust conduit to flow an effluent stream therethrough; three packed beds, disposed axially in the exhaust conduit and in a spaced apart relation, to remove non-exhaustible effluents from the effluent stream; one or more spray jets to provide an effluent treating agent between adjacent packed beds, the effluent treating agent to remove non-exhaustible effluents from the effluent stream; and a dripper disposed in the exhaust conduit above an uppermost packed bed to provide the effluent treating agent in large droplets, having an average diameter of between about 200 to 2000 microns, to wet and rinse particulate from an upper surface of the uppermost packed bed. Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic side view of a process apparatus in accordance with some embodiments of the present invention.

FIG. 2 depicts a schematic side view of a scrubber in accordance with some embodiments of the present invention.

FIGS. 3A-B depicts bottom and end-facing views of a dripper in accordance with some embodiments of the present invention.

FIGS. 4A-C side and bottom views of a dripper in accordance with some embodiments of the present invention.

FIG. 5 depicts a kinetic impactor and moisture trap in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Apparatus for improved treatment of effluents are provided herein. The inventive apparatus advantageously improves the capture of hazardous gases while maintaining and/or improving removal efficiency of particles from an exhausting effluent stream.

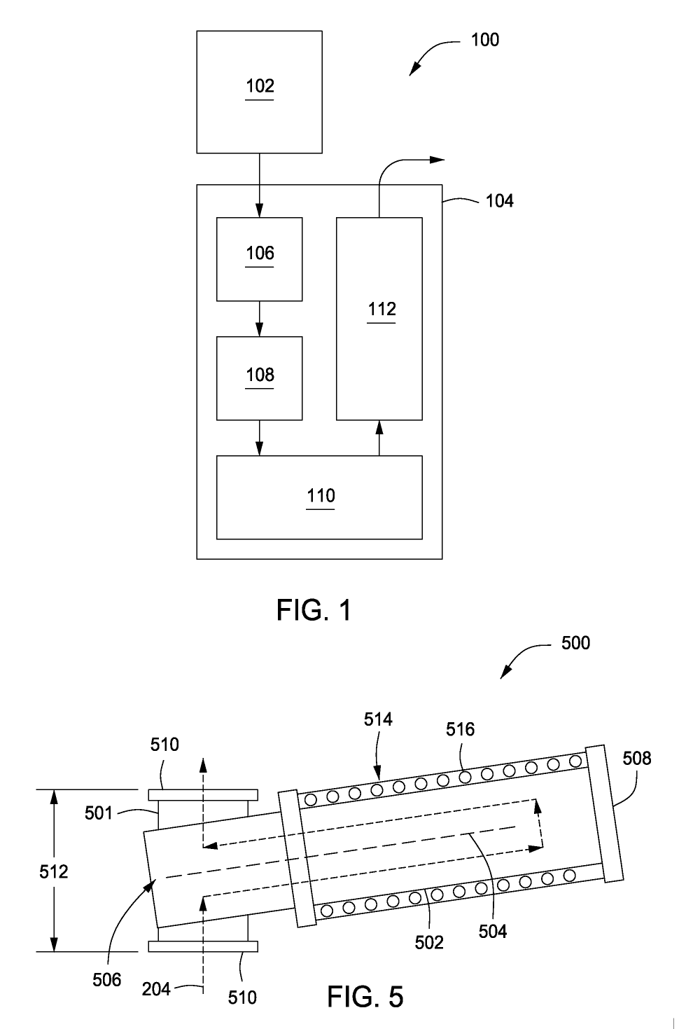

FIG. 1 depicts a schematic side view of a processing system 100 in accordance with some embodiments of the present invention. The exemplary processing system 100 includes a process chamber 102 coupled to an abatement system 104. The abatement system 104 is configured to process an exhausting effluent stream from the process chamber 102 to remove particles and/or hazardous gases from the effluent prior to releasing the remaining effluent into the environment.

The process chamber 102 may be any suitable process chamber, such as one or more of a semiconductor, flat panel, photovoltaic, organic light emitting diode (OLED), microelectromechanical systems (MEMS), or other silicon or thin film processing systems. The process chamber 102 may be configured for etch, deposition, plasma or any suitable processes associated with the aforementioned processing systems. Exemplary, non-limiting process chambers may include AKT® 60K for Solar, PRODUCER® eHarp for CVD, or ENABLER® E5 for Etch, available from Applied Materials, Inc. of Santa Clara, Calif.

An exhausting effluent stream from the process chamber 102 is directed to the abatement system 104, for example via appropriate conduits, pumps, valves, or the like (not shown). The abatement system 104 converts the effluent to an environmentally safe material, such as by removing non-desired components from the effluent, such as hazardous gases and/or particles from the effluent.

The abatement system 104 may be any suitable abatement system for receiving and processing the effluent from a process chamber, for example, the process chamber 104. The abatement system 104 may be employed to abate a single process chamber or tool, or multiple process chambers and/or tools. The abatement system 104 may use, for example, thermal, wet scrubbing, dry scrubbing, catalytic, plasma and/or similar means for the treatment of the effluent, as well as processes for converting the effluent to less toxic forms. The abatement system 104 may further include multiple abatement systems for processing particular types of effluents from a process chamber or a plurality of process chambers or other processing equipment having effluent to be abated. One exemplary abatement system may be the MARATHON® system, available from Applied Materials, Inc. of Santa Clara, Calif.

The abatement system 104 may include a thermal reactor 106 (i.e., combustion reactor), a water quenching apparatus 108, a separation tank 110, and a scrubber 112. The effluent stream, for example, including effluents such as a flammables and hydrocarbons, silanes, fluorocarbons, hydrogen, halogens, dopants, or the like may be flowed into the thermal reactor 106 of the abatement system 104 upon exhaust from the process chamber 102. The thermal reactor 106 may, for example burn effluents, such as saturated hydrocarbons in an atmosphere of an oxygen-containing gas such as oxygen (O₂) to form carbon dioxide (CO₂) and water (H₂O) which can be released into the environment. Further, the thermal reactor 106 may burn effluents, such as silanes, fluorocarbons, halogens, dopants, or the like in a similar atmosphere to form non-exhaustible effluents, such as hazardous gases (such as one or more of fluorine, chlorine, hydrogen chloride, hydrogen fluoride (HF), tetrafluorosilane (SiF₄), silicon dioxide (SiO₂), metal oxides, or the like), and/or particles, (such as silica (SiO₂), glass, metal oxides, organics, carbon, or the like), which must be removed from the exhausting effluent stream and not released into the environment. As used herein, the term non-exhaustible effluents means effluent that is not desired to be exhausted, for example due to environmental and/or safety regulations, and not effluent that is not capable of being exhausted.

The effluent stream treated by the thermal reactor 106 may next be flowed into the water quenching apparatus 108, where the effluent stream is cooled by contact with water, such as through a water spray or the like. The water quenching apparatus 108 can act to quench steam, such as formed from the combustion of hydrogen (H₂) and a fuel, such as a hydrocarbon, into liquid water. The water quenching apparatus 108 can further act to remove large particles, such as between about 0.1 micrometer to about 1 millimeter sized solids, from the effluent stream. For example, the large particles may comprise silica (SiO₂), metal oxides, or metal halide. The remaining effluent stream (i.e., those effluents not removed by the water quenching apparatus 108) flows into the tank 110, which is coupled to the water quenching apparatus 108. The remaining effluent stream may include finer particles, and water droplets such as those between about 10 nanometers to about 10 micrometers in size. These finer particles may comprise similar materials to the larger particles discussed above.

The tank 110 may further aid the reduction of particles from the remaining effluent stream. For example, in some embodiments, the tank 110 may include a first chamber and a second chamber separated by a solid or perforated wall (not shown). Each chamber is partially filled with water to a level sufficient to prevent the effluent from flowing directly from the first chamber to the second chamber without going through the water or being contacted by condensable water vapor.

A blower or water inductor (not shown) may be coupled between the first and second chambers for removing the gaseous portion of the remaining effluent stream from the first chamber and injecting it directly into the water below the water level of the second tank. The gaseous portion may be injected into the water of the second chamber via a diffuser (not shown) which releases the gaseous portion of the remaining effluent stream into the water of the second chamber in the form of fine bubbles. The bubbles allow the gaseous portion to have high surface area contact with the water and condensable water vapor to efficiently removal particles trapped in the gaseous portion of the remaining prior to reaching the water level of the second chamber. The second chamber may further include a mechanical fan or stirrer (not shown) to improve mixing of the water with the bubbles of the gaseous portion of the remaining effluent stream.

The remaining gaseous portion of the effluent stream exits the tank 110 and enters the scrubber 112 to further remove any remaining particles and/or hazardous gases from the remaining gaseous portion of the effluent stream prior to exhaust into a factory exhaust system or the environment.

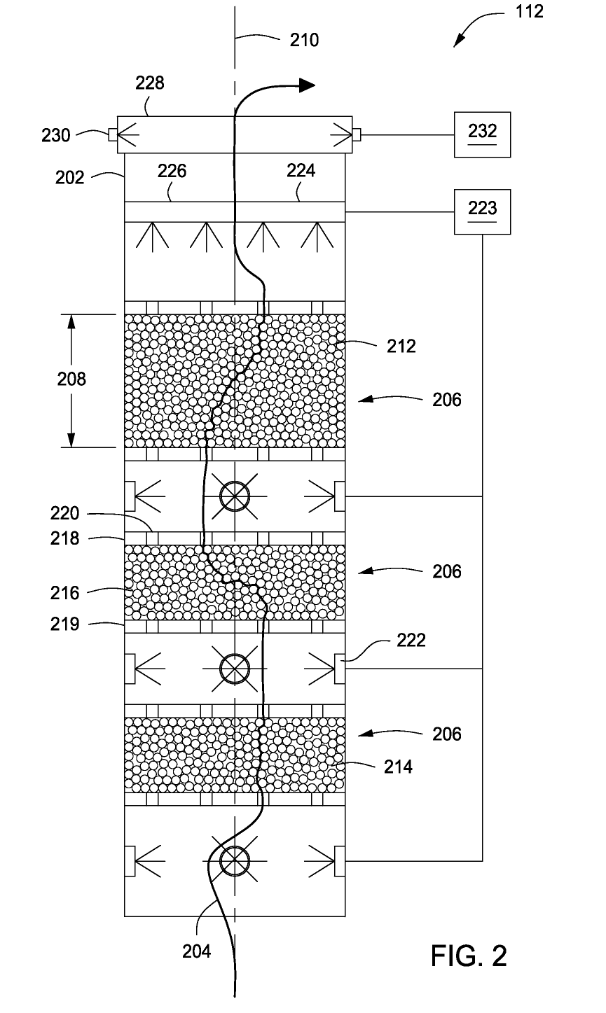

FIG. 2 depicts a schematic side view of the scrubber 112 in accordance with some embodiments of the present invention. The scrubber 112 includes an exhaust conduit 202 for flowing an exhausting effluent stream 204 (i.e., the remaining gaseous portion of the effluent stream received from the tank 110) therethrough. The exhaust conduit 202 may be any suitable shape to facilitate efficient removal of hazardous gases and/or particles from the effluent stream. For example, the exhaust conduit 202 may be cylindrical. The exhaust conduit 202 may comprise any suitable material compatible with abatement processes, for example, such as stainless steel, polyvinyl chloride (PVC), chlorinated PVC (CPVC), high nickel alloy, polypropylene, polyethylene, polyvinylidene fluoride (PVDF), or the like.

One or more packed beds 206 may be disposed in the exhaust conduit 202 for removing non-exhaustible effluents from the exhausting effluent stream 204 (three packed beds 206 illustratively shown in FIG. 2). Each packed bed 206 may be spaced apart as illustrated in FIG. 2. In some embodiments, the number of packed beds 206 may be between about 2 to about 10. A length 208 of each packed bed 206 as defined along a central axis 210 of the exhaust conduit 202 may be between about 5 to about 30 inches, although other dimensions may be used as necessary or desired for a particular application. In some embodiments, an uppermost packed bed 212 has a first length greater than a second length of a lowermost packed bed 214. In some embodiments, the first length of the uppermost packed bed 212 is between about 10 to about 15 inches. In some embodiments, the second length of the lowermost packed bed 214 is between about 5 to about 8 inches. In some embodiments, any packed bed between the uppermost and lowermost packed beds has a third length between about 5 to about 8 inches. The third length may be greater than or equal to the second length or less than or equal to the first length (i.e., equal to or between the length of the uppermost or lowest packed bed).

Each packed bed 206 further includes a plurality of non-exhaustible effluent sequestering objects 216 disposed between an upper and lower perforated plate 218, 219. The non-exhaustible sequestering objects 216 may be in any suitable size and shape necessary to create a torturous path for the effluent stream 204. The shape of each object 216 may include one or more of spherical, polyhedral, random, or the like. The size of each object 216 may have at least one dimension of between about ¼″ to about 2″ (such as an average diameter for approximately spherical shapes). Each object 216 may include any suitable material or materials for sequestering non-exhaustible effluents, such as high surface area material, for example, zeolites, alumina, spinel, glass, nickel, stainless steel, high nickel alloy, polypropylene, polyethylene, PVC, CPVC, PVDF, cellulose, or the like, or other materials, such as carbon rings, or the like.

The upper and lower perforated plates 218, 219 may act to hold the objects 216 in place in the exhaust conduit 202. The perforated plates 218, 219 may include any suitable size, shape and pattern of holes 220 for passing the exhaust stream 204 therethrough. The size, shape and pattern of the holes 220 may be further utilized to control residence time of the exhaust stream in each packed bed and to distribute the gas flow evenly across the cross section of the scrubber.206.

The scrubber 112 further includes a plurality of spray jets 222 disposed in or about the walls of the exhaust conduit 202 (as shown) or across the cross section of the exhaust conduit 202 (not shown). In some embodiments, one or more spray jets 222 may be disposed adjacent to each packed bed 206, or between each packed bed 222. In some embodiments, one or more spray jets 222 may be disposed below the lowermost packed bed 214. Each spray jet 222 may be coupled to an effluent treating agent source 223 to provide an effluent treating agent that interacts with exhausting effluent stream 204 to remove non-exhaustible effluents therefrom. The effluent treating agent may include one or more of water (H₂O), a caustic, an acid, an ionic or non ionic surfactant, or an agglomerating agents. In some embodiments, the effluent treating agent may be water or water having one or more of a caustic, an acid, an ionic or non ionic surfactant, or an agglomerating agent mixed therein. In some embodiments where the effluent treating agent includes water, the water may be fresh water (sometimes referred to as fresh make-up water) or reticulated water from the tank 110.

Each spray jet 222 may be any suitable shape or structure for dispensing the effluent treating agent. For example, each spray jet 222 may include a nozzle or other similar apparatus for dispensing the effluent treating agent as a spray, mist or the like. The spray jets 222 may be oriented about the wall of the exhaust conduit 202 in any suitable configuration appropriate to maximize interaction of the effluent treating agent with the effluent stream 204. For example, several spray jets 222 may be disposed about the wall of the exhaust conduit 202 between adjacent packed beds 206 as illustrated in FIG. 2.

In some embodiments, the spray jets 222 may be adjustable for varying the intensity of the spray or the flow rate of the effluent treating agent. For some process recipes, or during idle mode, for example, the recirculating water flow rate and fresh water flow addition may vary as a function of time or process step. For some operating conditions, a fine mist or alternately large droplets of scrubbing fluid (e.g., the effluent treating agent) may be used at various axial positions along the conduit. Changing the water feed pressure can dynamically control the shape of the spray pattern. In some embodiments, the spray jets 222 disposed above the lowermost packed bed 214 may be configured to provide a fine mist. Sets of spray jets disposed above succeeding packed beds along the scrubber 112 may provide increasingly coarse (i.e., larger) average droplet sizes. The inventors have discovered that a fine mist, or any high surface area distribution of the effluent treating agent improves the sequestering of fine particles, such as silica (SiO₂) or the like, from the effluent stream 204. However, the inventors have further discovered that such a fine mist may undesirably be carried along the effluent stream out of the scrubber and to atmosphere or other post-abatement effluent handling equipment, particularly if provided near the downstream end of the scrubber 112. Accordingly, the arrangement of progressively coarser spray jets may provide particle reduction with a lower likelihood of droplets of the effluent treating agent being carried out of the scrubber 112 in the effluent stream due to the larger mass of the spray droplets.

To further assist in reducing the likelihood of droplets of the effluent treating agent being carried out of the scrubber 112, in some embodiments, the uppermost packing bed 212 may be provided as a demister and used without spray jets 222 being provided downstream. In some embodiments, a dripper 224 may be disposed above the uppermost packed bed 212. The dripper 224 may be disposed in the exhaust conduit 202 above the uppermost packed bed 212. The dripper 224 may provide the effluent treating agent counter to a flow direction of the exhausting effluent stream 204 to remove non-exhaustible effluents therefrom. Rather than the fine mist or coarse spray provided by the spray jets 222, the dripper 224 may provide large droplets of the effluent treating agent (e.g., a drip). The large droplets from the dripper 224 may cover the upper packing to create a wet surface without creating a mist from the spray. In some embodiments, a spray or fine mist may be defined as having an average droplet size from about 0.1 to 10 microns and the larger droplets used near the top of the fluid scrubber may range from about 200 to 2000 microns. The inventors have discovered that providing a coarse drip of effluent treating agent further improves the sequestering of hazardous gases, such as hydrogen fluoride (HF) or tetrafluorosilane (SiH₄) from the effluent stream 204 while reducing the fine mist carry over from fine mist generated below the reactor or lower (e.g., upstream) in the scrubber 112.

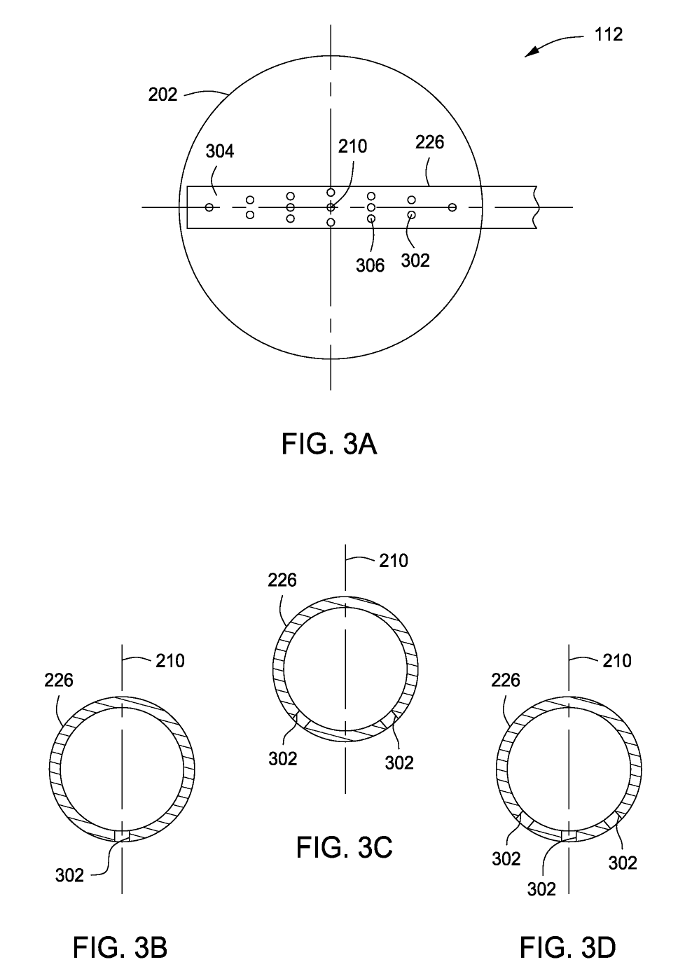

In some embodiments, the dripper 224 comprises a second conduit 226 extending from a wall of the exhaust conduit 202 and across the diameter thereof. The second conduit 226 may extend completely across the exhaust conduit 202 (and may be supported by both sides of the exhaust conduit 202) or may be cantilevered into the exhaust conduit 202 and supported by only one side of the exhaust conduit 202 (as depicted in FIG. 2). Embodiments of the dripper 224 including the second conduit 226 are illustrated in FIGS. 2 and 3A-B.

FIG. 3A depicts a bottom view of the second conduit 226 in accordance with some embodiments of the present invention. The second conduit 226 includes a plurality of outlets 302 disposed on a side 304 of the second conduit 226 facing the oncoming effluent stream for providing the effluent treating agent therefrom. In some embodiments, at least one of the outlets 302 is angled with respect to a central axis 210 of the exhaust conduit 226.

The plurality of outlets 302, and their varying diameters and geometries, can be arranged to provide a uniform droplet spray pattern and positional fluid flow rate that roughly corresponds to the shape of the exhaust conduit 226. For example, as illustrated in FIG. 3A, the plurality of outlets 302 can be arranged in a plurality of rows 306 disposed perpendicular to the central axis of the second conduit 226. Each row 306 can extend partially along a circumference of the second conduit 226 on the effluent stream facing side 304 thereof.

The number of outlets and/or the spacing between outlets 302 in a row 306 can vary between different rows 306 along the second conduit 226 to provide the desired spray pattern. For example, the number of outlets and/or the spacing between outlets 302 may increase from rows 306 proximate the walls of the exhaust conduit 202 to rows 306 proximate a central axis 210 of the exhaust conduit 202. In some embodiments, and as illustrated in FIG. 3A, the number of outlets 302 in each row 306 increases and the spacing between each outlet 302 in each row 306 increases from rows near the walls of the exhaust conduit 202 to rows near the central axis 210 thereof.

The spacing of the outlets 302 in each row 306 may be varied, for example, by changing the angle of one or more outlets 302 in each row 306, as illustrated in FIGS. 3B-D. For example, FIGS. 3B-D depict cross-sectional views of the second conduit 226 along lines cutting through different rows 306 of the dripper 224.

As illustrated, each row 306 may illustratively include one outlet (FIG. 3B), two outlets (FIG. 3C), or a three outlets (FIG. 3D). Other numbers of outlets or variations from row to row or along the second conduit 226 are contemplated. The one-outlet row may comprise one outlet 302 oriented parallel to the central axis 210 of the exhaust conduit 226. The two-outlet row may comprise two outlets 302 symmetrically angled with respect to the central axis 210 of the exhaust conduit 226. In some embodiments, each outlet 302 of the two-outlet row may be angled at about 45 degrees or less with respect to the central axis of the exhaust conduit. The three-outlet row may comprise three outlets 302, where one central outlet is oriented parallel to the central axis of the exhaust conduit and is disposed between two outlets symmetrically angled with respect to a central axis of the exhaust conduit. In some embodiments, each angled outlet of the three-outlet row may be angled between about 30 to about 60 degrees with respect to the central axis of the exhaust conduit.

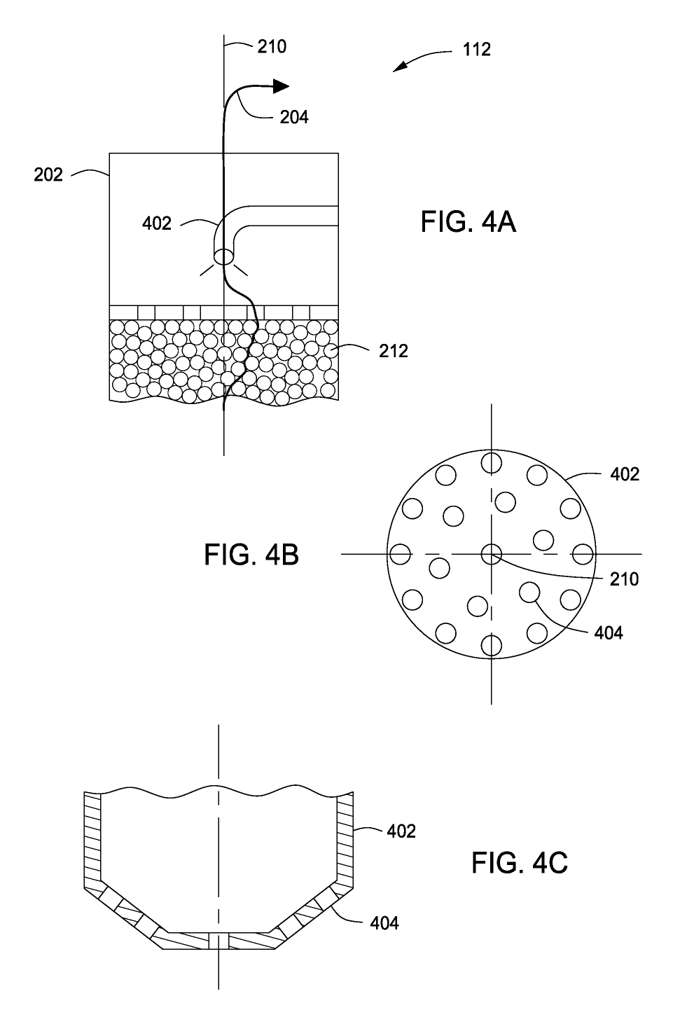

FIGS. 4A-C depict an alternative embodiment of the dripper 224 in accordance with some embodiments of the present invention. For example, in FIG. 4A, the dripper 224 includes a showerhead 402 centrally disposed in the exhaust conduit 226 above the uppermost packed bed 212. Similar to the second conduit 226, the showerhead 402 may provide the effluent treating agent at a desired flow rate and droplet size counter to the flow direction of the effluent stream 204 in a desired pattern, for example, corresponding to the shape of the exhaust conduit 226. The showerhead 402 includes a plurality of outlets 404 for providing the effluent treating agent therefrom. In some embodiments, at least some of the outlets 404 are radially disposed about a central axis 210 of the exhaust conduit 226 and angled with respect thereto as shown in bottom and side views of the showerhead 402 in FIGS. 4B-C. In some embodiments, at least one outlet 404 is centrally disposed along the central axis 210 of the exhaust conduit and parallel thereto.

Returning to FIG. 2, in some embodiments, a moisture suppression device 228 may be disposed downstream of the uppermost packed bed 212 (or the dripper 224, when present) proximate the exit of the exhaust conduit 202 of the scrubber 112. The moisture suppression device 228 may provide room air or cool dry air to dry out or reduce the humidity of the effluent stream. For example, the moisture suppression device 228 may have one or more inlets 230 that may be coupled to an air source 232 to provide air into the effluent stream 204. As noted above, the air source 232 may provide room air or cool dry air to the effluent stream.

In operation and in some embodiments, and referring to FIG. 2, the exhausting effluent stream 204 comprising hazardous gases and/or particles enters the exhaust conduit 202 and may be exposed to a spray and/or mist of the effluent treating agent provided by the plurality of spray jets 222 disposed prior to the lowermost packed bed 214. The exhausting effluent stream 204 then enters the lowermost packed bed 214 where the effluent stream 204 moves through a torturous path of the effluent sequestering objects 216 where hazardous gases and/or particles are removed from the effluent stream 204. The effluent stream 204 exits the lowermost packed bed 214 and is again treated with the effluent treating agent provided by a plurality of the spray jets 222 disposed above the lowermost packed bed 212. In some embodiments, each successive treatment of the effluent treating agent provided by the spray jets 222 may be a more coarse spray than the previous treatment to limit the quantity of fine spray droplets entrained in the effluent stream 204. The effluent stream 204 continues to flow upward through the plurality of packed beds 206 in a torturous path until, in some embodiments, it is met with the drip of large droplets of the effluent treating agent provided by the dripper 224 above the uppermost packed bed 212. The large droplets provided by the dripper 224 may further aid in the sequestering of hazardous gases from the effluent stream 204 prior to release into the environment or factory exhaust system while not providing small droplets of the effluent treating agent that may be carried out of the scrubber 112 via the flow of the effluent stream. In some embodiments, room air or cool dry air may be provided to the remaining effluent stream by the moisture suppression device 228 to further cool and dry the effluent stream.

In some embodiments, prior to release into the environment or factory exhaust system, the effluent stream 204 may flow through an optional moisture trap 500 disposed downstream of the scrubber 112 (or at a downstream end of the exhaust conduit 202 of the scrubber 112, for example downstream of the uppermost packed bed 212, the dripper 224 when present, and the moisture suppression device 228 when present). FIG. 5 depicts a kinetic impactor and moisture trap 500 in accordance with some embodiments of the present invention. The kinetic impactor and moisture trap 500 includes a first conduit 501 disposed in-line with the abatement exhaust, for example in-line with exhaust conduit 202 of the scrubber 112. Flanges 510 may be provided at either end of the first conduit 501 for ease of installation and removal. In some embodiments, the first conduit 501, and the kinetic impactor and moisture trap 500 overall, may have a low vertical footprint to facilitate use in small spaces. For example, in some embodiments the first conduit 501 may have a length 512 of about 12 inches.

A second conduit 502 is fluidly coupled to the first conduit 501 at a slight elevated angle thereto. In some embodiments, the second conduit 502 may have a length of between about two to three feet. A central diverter partition 504 may be disposed within the second conduit 502 to force the effluent stream 204 around a longer/torturous flow path to exit the conduit 501. The partition 504 provides a surface for moisture (e.g., water vapor) from the exhaust stream 204 to condense thereon. Once condensed, the captured moisture may flow back into the exhaust conduit 202 via a drain 506 disposed in the partition 504 proximate the intersection of the partition 504 and the base of second conduit 502. In some embodiments, a flange 508 may be provided on an outer end of the second conduit 502 (opposite the base). The flange may be configured to provide a viewpoint into the moisture trap 500 for inspection and/or a connection for washing down the kinetic impactor and moisture trap 500.

In some embodiments, a cooling jacket 514 may be provided to cool the effluent flowing through the moisture trap. The cooling jacket may include a cooling coil 516 wrapped around the second conduit 502 to remove heat from the surfaces of the second conduit 502, which then facilitates greater heat transfer from the effluent to the cooled surfaces of the second conduit 502. The cooling coil 516 may be part of a chiller loop (not shown) to flow a heat transfer fluid through the cooling coil 516.

Thus, apparatus for improved treatment of effluents are provided herein. The inventive apparatus advantageously improves the capture of hazardous gases while further maintaining removal efficiency of particles from an exhausting effluent stream.

While the foregoing is directed to embodiments of the present invention, other and further embodiments of the invention may be devised without departing from the basic scope thereof.

1. An abatement system, comprising:
an exhaust conduit to flow an effluent stream therethrough;
a plurality of packed beds disposed in the exhaust conduit to remove non-exhaustible effluents from the effluent stream;
one or more spray jets configured to provide an effluent treating agent between adjacent packed beds, the effluent treating agent to remove non-exhaustible effluents from the effluent stream; and
a dripper disposed in the exhaust conduit above an uppermost packed bed to provide the effluent treating agent in large droplets to wet and rinse particulate from an upper surface of the uppermost packed bed substantially without forming fine droplets.

2. The system of claim 1, wherein the dripper further comprises:
a showerhead disposed in the exhaust conduit above the uppermost packed bed to provide the effluent treating agent therefrom.

3. The system of claim 2, wherein the showerhead further comprises:
a plurality of outlets configured to provide a spray pattern that matches the general shape of the exhaust conduit.

4. The system of claim 1, wherein the dripper further comprises:
a second conduit extending from a wall of the exhaust conduit, the second conduit having a plurality of outlets disposed on an upstream facing side of the second conduit to provide the effluent treating agent therefrom.

5. The system of claim 4, wherein the plurality of outlets are configured to provide a spray pattern that matches the general shape of the exhaust conduit.

6. The system of claim 5, wherein the plurality of outlets are arranged in a plurality of rows along the length of the second conduit, each row extending partially along the circumference of the second conduit on the upstream facing side.

7. The system of claim 6, wherein the number of outlets in a row increases along the length of the second conduit between positions proximate walls of the exhaust conduit and positions proximate a central axis of the exhaust conduit.

8. The system of claim 6, wherein each row comprises one outlet, two outlets, or three outlets.

9. The system of claim 8, wherein each one outlet row has one outlet oriented parallel to a central axis of the exhaust conduit, wherein each two outlet row has two outlets symmetrically angled with respect to the central axis, and wherein each three outlet row has one central outlet, oriented parallel to the central axis, and disposed between two outlets symmetrically angled with respect to the central axis.

10. The system of claim 9, wherein each outlet of the two-outlet row is angled at about 45 degrees or less with respect to the central axis, and wherein each angled outlet of the three outlet row is angled between about 30 to about 60 degrees with respect to the central axis.

11. The system of claim 1, wherein the dripper provides effluent treating agent droplets having an average diameter of greater than or equal to about 200 microns.

12. The system of claim 1, wherein the dripper provides effluent treating agent droplets having an average diameter of between about 200 to 2000 microns.

13. The system of claim 1, wherein fine droplets have an average diameter of between about 0.1 to 10 microns.

14. The system of claim 1, wherein the plurality of packed beds may number from about 2 to about 10.

15. The system of claim 1, wherein an axial length of each packed bed is between about 5 to about 30 inches.

16. The system of claim 15, wherein the uppermost packed bed has an axial length that is greater than an axial length of a lowermost packed bed.

17. The system of claim 16, wherein the axial length of the uppermost packed bed is between about 10 to about 15 inches.

18. The system of claim 16, wherein the axial length of the lowermost packed bed is between about 5 to about 8 inches.

19. The system of claim 16, wherein a packed bed disposed between the uppermost and lowermost packed beds has an axial length of between about 5 to about 8 inches.

20. The system of claim 1, wherein the non-exhaustible effluents comprise one or more of particulates or hazardous gases.

21. The system of claim 1, wherein the effluent treating agent comprises one or more of water (H₂O), caustic, acid, ionic or non ionic surfactants, or agglomerating agents.

22. The system of claim 1, further comprising:
a combustion chamber configured to receive and combust effluent;
a quenching apparatus disposed downstream of the combustion chamber to quench the effluent flowing from the combustion chamber;
a separation tank disposed downstream of the quenching apparatus to receive the effluent flowing from the quenching apparatus; and
wherein the exhaust conduit, plurality of packed beds, one or more spray jets, and dripper are part of a scrubber disposed downstream of the separation tank to receive the effluent flowing from the separation tank.

23. An abatement system, comprising:
an exhaust conduit to flow an effluent stream therethrough;
three packed beds, disposed axially in the exhaust conduit and in a spaced apart relation, to remove non-exhaustible effluents from the effluent stream;
one or more spray jets to provide an effluent treating agent between adjacent packed beds, the effluent treating agent to remove non-exhaustible effluents from the effluent stream; and
a dripper disposed in the exhaust conduit above an uppermost packed bed to provide the effluent treating agent in large droplets, having an average diameter of between about 200 to 2000 microns, to wet and rinse particulate from an upper surface of the uppermost packed bed.
